(19) United States
(12) Patent Application Publication
(10) Pub. No.: US 2015/0313782 A1
(43) Pub. Date: Nov. 5, 2015

(54) LEG UP THERAPEUTIC LEG SUPPORT

(71) Applicant: Bridget Mulholland, Kennett Square, PA (US)

(72) Inventor: Bridget Mulholland, Kennett Square, PA (US)

(21) Appl. No.: 14/686,709

(22) Filed: Apr. 14, 2015

Related U.S. Application Data
(60) Provisional application No. 61/979,066, filed on Apr. 14, 2014.

(51) Int. Cl. A61G 7/075; A61G 5/12

(52) U.S. Cl. CPC A61G 7/0755; A61G 5/12; A61G 2005/127

(57) ABSTRACT

A therapeutic device to support a persons leg, suitable for use with a chair or a bed, having a seat and extension and support means. The support means can be held in a horizontal position, or can be folded down, perpendicular to the seat, or it can be folding completely under the seat for storage.

### CLAIM OF PRIORITY

This patent application claims priority under 35 USC 119 (e) (1) from U.S. Provisional Patent Application Ser. No. 61/979,066 filed Apr. 14, 2014, of common inventorship herewith entitled, “A Leg Up,” which is incorporated herein by reference as though the same were set forth in its entirety.

### FIELD OF THE INVENTION

The present invention pertains to the field of medical equipment, and more specifically to the field of elevated leg supports.

### BACKGROUND OF THE INVENTION

The prior art has put forth several designs for elevated leg supports. Among these are:

U.S. Pat. No. 866,316 to Henry B. Watson describes a leg and foot rest comprising a hinged board mounted to the seat of a chair by means of a hooked rod.

U.S. Pat. No. 5,449,221 to Maxwell Stander describes a portable leg rest having a thin rectangular platform with a leg supporting upper surface and hinges that pivotally connect to a seating portion that is placed on a chair, bench or sofa. The leg rest is extended and supported by folding legs that pivot from the underside of the leg rest and position on the floor or ground. This provides an elevated leg rest in which the height and angle is adjusted by manually varying the length of the supporting legs. The hinges permit the leg rest to swing from the near horizontal position downward to the folded, transport position lying flat against the lower surface of the seating portion. Stops on the leg rest support leg pivots limit the distance it can move forward of the leg rest. The assembly is quickly and conveniently lifted from the seating surface, folded essentially flat, and held temporarily closed for storage or carried to another seating surface. The assembly is opened up quickly by disengaging the hook and loop fastenings, unsnapping the leg rest support from the clip, opening the seat, placing it upon the chair, bench or sofa and placing the support on the floor or ground.

U.S. Pat. No. 5,154,484 to Donald C. Aronson describes a portable foot and leg rest including a frame, one end of which is temporarily supported by the edge of a chair or couch. The other end of the frame carries legs which are pivotal between a storage position in which they are parallel to the frame and a rotated position in which they are generally perpendicular to and support the frame in a generally horizontal position. The length of the leg assemblies are adjustable so the far end of the frame is level with, higher than or lower than the end of the frame supported on the chair or couch. A cushion assembly is carried by the frame for selective sliding movement toward and away from the point at which the frame is supported by a chair or couch to accommodate the varying leg length of users.

U.S. Pat. No. 2,614,613 to Helen W. Bushong describes a convenient and efficient support for a person's legs while sitting, this being arranged so the leg is sustained in a substantially horizontal, outstretched position with respect to the level of a chair or the like on which the user is seated. An important capability of the invention resides in its foldability, which permits it to be conveniently collapsed and carried when it is not in use.

None of these prior art references describe the present invention.

### SUMMARY OF THE INVENTION

It is an object of the present invention to provide a seat cushion suitable for use with a chair or a bed and equipped with a horizontal extension that comfortably and securely supports a person's right or left leg which is elevated to reduce pain or swelling due to injury, post surgical recovery or circulatory problems.

### BRIEF DESCRIPTION OF THE DRAWINGS

FIG. 1 is an illustrative prototypical top down diagonal view of the present invention showing a molded seat that is connected to an extendable leg support residing in an up position and covered with a removable and washable pad cover.

FIG. 2 is an illustrative prototypical top down front diagonal view of the present invention showing a molded seat for holding a user's buttocks and an extendable leg support in a folded down position.

FIG. 3 is an illustrative prototypical top down front diagonal view of the present invention showing a simple handgrip and a functioning leg support that is adjusted to support a right leg and is extended to accommodate a longer leg.

FIG. 4 is an illustrative prototypical top down back diagonal view of the present invention showing a non slip material covering its underside surface and a hinge allowing the extendable leg support to be folded under the bottom surface when user is getting out of the seat or when the present invention is being stored.

FIG. 5 is an illustrative prototypical top down front diagonal view showing padded seat and leg support covers fabricated in stain resistant and washable material.

### DETAILED DESCRIPTION OF THE INVENTION

Active people at some point in their lives, almost every individual sprains or breaks an ankle, requires a knee surgery or otherwise suffers some injury to a leg which requires them to elevate the affected leg for some period of time. With aging, more and more people experience circulatory problems, diabetes and other conditions which require elevating a leg to reduce swelling. Unless one is in a wheelchair, makeshift methods are employed for elevating one's leg such as pillows, cushions or an extra chair.

The present invention, hereinafter referred to as A Leg Up Therapeutic Leg Support, or simply A Leg Up, is a molded seat suitable for use with a chair, sofa or a bed and is equipped with a horizontal extension support for a right or left leg. A Leg Up provides a comfortable and secure support for persons who must elevate a leg to reduce pain or swelling due to injury, post surgical recovery or circulatory problems. A Leg Up is a form fitting, molded seat 12 and padded seat cushion for use on a chair or on a bed, comprising a leg support 14 that elevates and comfortably supports a person's right or left leg. A Leg Up is a contoured seat cushion 12 sized in Small, Medium and Large, equipped with its own machine washable cover and firmly molded to retain its shape and be equally comfortable when laid in a chair seat or on the side of a bed. The material of A Leg Up seat cushion is cool and breathable, preferably a visco elastic thermopolymer such as MEMORY FOAM™ which is used for beds and pillows. Other dense foam is also suitable for use in manufacturing the seat portion of the present invention The bottom of the seat cushion 12 is fabricated in a contoured, hard plastic polymer. This polymer foundation anchors and supports A Leg Up's horizontal leg support 14.

The therapeutic device of the present invention comprises a seat having a bottom side, a top side and a front edge, suitable for use with a chair or a bed, a leg support that comfortably and securely supports a person's leg, and an extension having a proximal end and a distal end, for attaching the leg support to the seat in a desired position wherein the seat is capable of being placed on a chair or bed, further wherein the extension is attached to the bottom side of the seat at the proximal end of the extension by means of a mounting socket, wherein the mounting socket is mounted to the front edge of the bottom side of the seat, and further wherein the leg support is mounted to the distal end of the extension, and further wherein the leg support is held in a horizontal position.

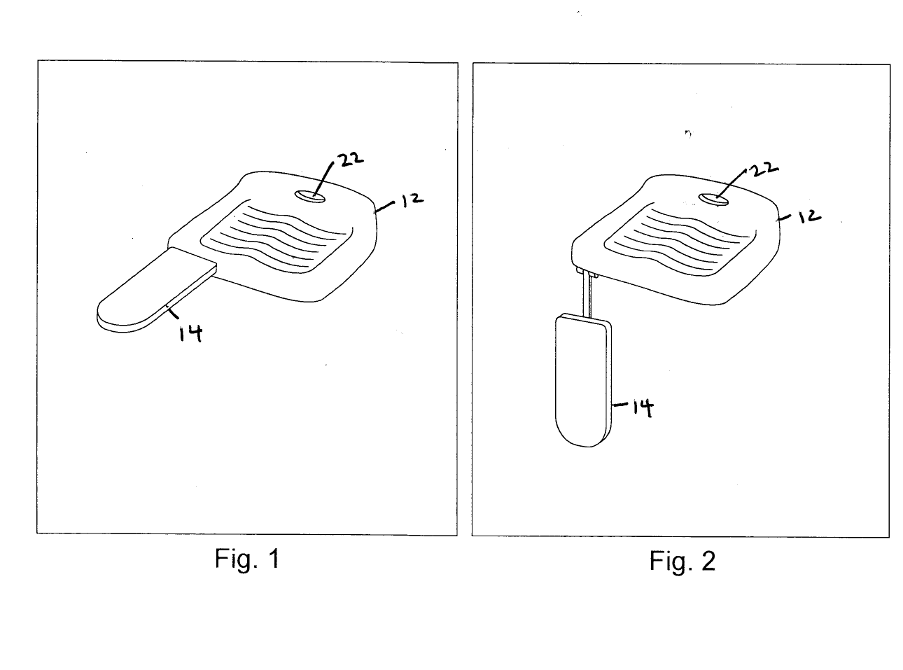

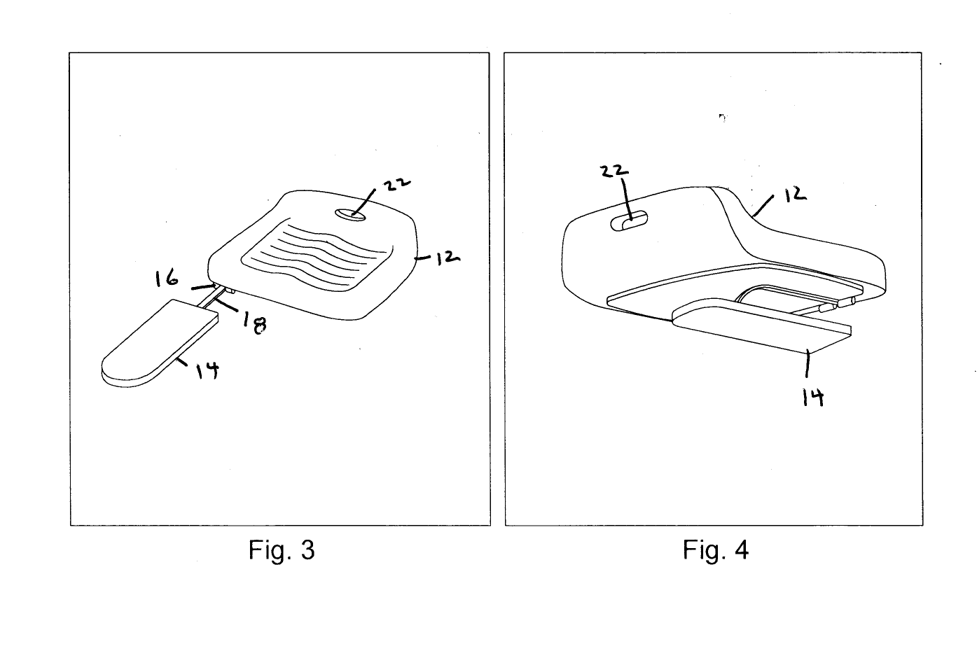

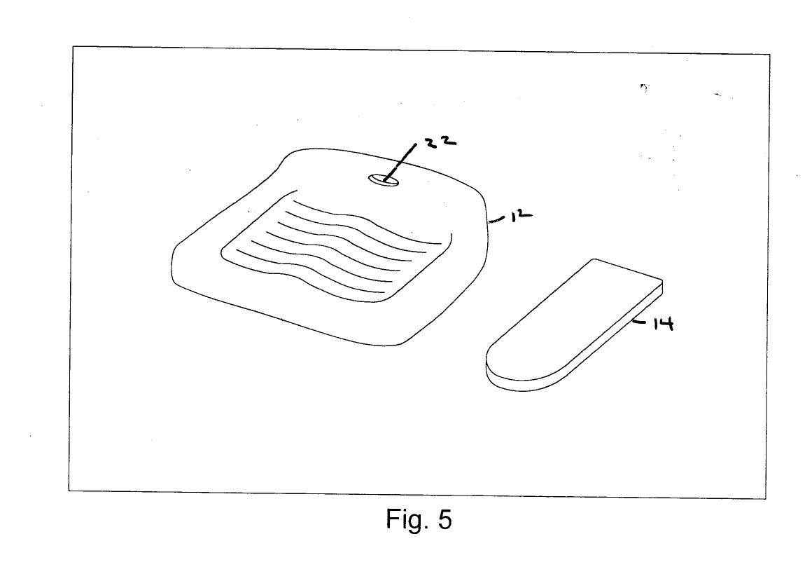

In an embodiment, A Leg Up is produced in both a right leg and left leg version. In an alternative embodiment, the seat cushion 14 comprises hard plastic foundation with hinged mounting socket 16 on both right and left sides. Hinged socket 16 allows leg support 14 to be folded down, as shown in FIG. 2. Hinged socket 16 also allows leg support 14 to be folded back underneath the seat 12, as shown in FIG. 4. The configuration shown in FIG. 4 allows for convenient storage of the device when not in use. The leg support 14 attaches to the seat 12 by any suitable attachments such as bolts or screws, and is capable of being secured into the right or left socket 16 in the bottom of the seat cushion, extending straight out to support a user's leg. FIGS. 1, 2 and 3 show socket 16 on the right side of seat 12, but socket 16 can also be mounted to the left side of seat 12. While A Leg Up's extending leg support 14 is produced in Small, Medium and Large sizes, it also is available with a telescoping or sectional extension 18 which is adjustable in length to accommodate various users. Extension 18 is shown in FIG. 3. The leg support 14 can be paddle shaped, as shown. Extension 18 is tubular, preferably a powder coated aluminum alloy where it anchors beneath the cushion 12. One embodiment of leg support 14 is constructed as a simple flat foam covered pad. An alternative embodiment of this leg support 14 is a concave, foam covered rest that supports and cradles the leg, thus protecting a leg from becoming dislodged. Like the seat cushion, the leg support 14 is equipped with a comfortable, breathable and machine washable slipcase cover. The seat 12 also has a handle opening 22 in the center of the back of the seat near the top of the seat to facilitate handling the device. The sides of the seat cushion foundation are equipped with a pair of fold out brackets (not shown) which add increased stability when A Leg Up is being used as a bedside seat.

A Leg Up provides secure and comfortable support for anyone with a need to elevate a leg including post operative patients in a health care setting, people recovering at home from injuries ranging from broken legs to sprained ankles, people with diabetes or circulatory problems that result in swelling of the feet or legs. Durably and cleverly constructed, A Leg Up will withstand many years of highly effective and functional use.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A therapeutic device comprising: a seat having a bottom side, a top side and a front edge, suitable for use with a chair or a bed, a leg support that comfortably and securely supports a person's leg, and an extension having a proximal end and a distal end, for attaching the leg support to the seat in a desired position wherein the seat is capable of being placed on a chair or bed, further wherein the extension is attached to the bottom side of the seat at the proximal end of the extension by means of a mounting socket, wherein the mounting socket is mounted to the front edge of the bottom side of the seat, and further wherein the leg support is mounted to the distal end of the extension, and further wherein the leg support is held in a horizontal position.

2. The therapeutic device of claim 1, further comprising a hinge in the mounting socket to allow the leg support to be folded.

3. The therapeutic device of claim 2, wherein the hinge allows the extension to be folded down so the leg support is perpendicular to the plane of the seat.

4. The therapeutic device of claim 2, wherein the hinge allows the extension to be folded and under the seat so the leg support is parallel to the seat.

5. The therapeutic device of claim 1, further comprising a machine washable cover.

6. The therapeutic device of claim 1, wherein the device is made in small, medium and large sizes.

7. The therapeutic device of claim 1, further comprising a handle opening in the seat.

8. The therapeutic device of claim 1, wherein the seat comprises a visco elastic thermopolymer such as MEMORY FOAM™.

9. The therapeutic device of claim 1, wherein the seat is fabricated in a contoured, hard plastic polymer.

10. The therapeutic device of claim 1, further comprising a mounting socket for holding the extension, wherein the mounting socket is mounted to the front edge of the seat.

11. The therapeutic device of claim 9 wherein the mounting socket can be mounted on the left side or right of the front edge of the seat.

11. The therapeutic device of claim 1, having two mounting sockets, wherein one mounting socket is mounted to the right side of the front edge of the seat and the second mounting socket is mounted to the left side of the front edge of the seat.

12. The therapeutic device of claim 1 wherein the extension is adjustable in length.

13. The therapeutic device of claim 12 wherein the adjustable length extension comprises a telescoping extension.

14. The therapeutic device of claim 12 wherein the adjustable length extension comprises a sectional extension.
